(19) United States
(12) Patent Application Publication
(10) Pub. No.: US 2024/0016192 A1
(43) Pub. Date: Jan. 18, 2024

(54) COOKED RICE IMPROVER AND METHOD OF PRODUCING COOKED RICE

(71) Applicants: KEWPIE CORPORATION, Tokyo (JP); Kewpie Jyozo Co., Ltd., Tokyo (JP)

(72) Inventors: Akifumi MIKAMI, Tokyo (JP); Hideaki KOBAYASHI, Tokyo (JP); Mayumi HIDAN, Tokyo (JP); Wataru URUSHIBATA, Tokyo (JP); Ryosuke HOSHINA, Tokyo (JP); Kenta SUSAKI, Tokyo (JP)

(21) Appl. No.: 18/036,010

(22) PCT Filed: Nov. 26, 2021
(86) PCT No.: PCT/JP2021/043390

§ 371 Date: May 9, 2023

(30) Foreign Application Priority Data
Nov. 30, 2020 (JP) 2020-198873

(51) Int. Cl. A23L 7/196; A23L 33/115

(52) U.S. Cl. CPC A23L 7/1965; A23L 33/115

(57) ABSTRACT

A cooked rice improver, which allows fat and oil to be easily emulsified immediately after being added, is excellent in the effect of releasing cooked rice, reduces breakage of rice grains and makes the graininess of rice excellent, suppresses aging of cooked rice, and allows cooked rice with improved richness and excellent flavor to be obtained. The cooked rice improver contains fat and oil, an ionic surfactant, and a polyhydric alcohol, wherein a content of the fat and oil is 8% by mass or more and 65% by mass or less with respect to a total amount of the cooked rice improver, and a difference of L2 value−L1 value calculated at 20° C. according to the following definition is positive: L1 value: lightness value of cooked rice improver; L2 value: lightness value of emulsion obtained by adding 100 times by mass of fresh water to the cooked rice improver.

### BACKGROUND OF THE INVENTION

### Technical Field

The present invention relates to a cooked rice improver and a method of producing cooked rice. In particular, the present invention relates to a cooked rice improver containing fat and oil, an ionic surfactant, and a polyhydric alcohol, and a method of producing cooked rice.

### Background Art

Cooked rice is sold in various forms in supermarkets, convenience stores, and the like. For example, cooked rice is sold in a container-packed form as a staple food for commercially available boxed lunches and is also sold in the form of only rice packed in a transparent plastic container for consumption on the day. Most of these forms of cooked rice are eaten as is, or heated in a microwave oven, if necessary. Meanwhile, since cooked rice can be easily applied to other rice dishes such as fried rice, omelet rice, rice porridge, or the like, in recent years, the sales volume has increased for home and business use.

Commercially available cooked rice is cooked in significant quantities by machinery, and thus if starch paste or rice grains adhere to the machinery, the production yield will drop, Therefore, it is usual to add oil for cooking rice containing an emulsifier as a release agent to uncooked rice and water in preparation. However, a problem with a large rice cooker is that the oil does not spread all over, resulting in unevenness. To solve such a problem, the unevenness has been eliminated by sufficiently stirring after adding oil for cooking rice as a release agent. However, stirring increased the amount of crushed rice, which tended to lead to deterioration in the quality of cooked rice. There is also a technique to improve dispersibility by adding water to oil for rice cooking for emulsifying by mechanical stirring just before preparation, which, however, required special machinery and was not widely available. Further, to solve the above problems, it has been proposed to prepare a pre-emulsified emulsion to be added to cooked rice as a release agent and use it hen preparing for cooking ice (see Patent Literature 1 and 2).

### CITATION LIST

### Patent Literature

Patent Literature 1: Japanese Laid-Open Patent Publication No. H6-197711 (1994)

Patent Literature 2: Japanese Laid-Open Patent Publication No. H7-163306 (1995)

### SUMMARY OF THE INVENTION

### Technical Problem

Oxidative deterioration of fat and oil in oil-in-water emulsions to be added to cooked rice, as described in Patent Literature 1 and 2, is likely to progress. Even if an oil-in-water emulsion is packed in an airtight container during distribution, it takes several hours to several days after opening until it can be used for cooking rice. After all, there is a problem that the oxidative deterioration of fat and oil causes an unpleasant odor of cooked rice.

Therefore, an object of the present invention is to provide a cooked rice improver, which is not pre-emulsified into an oil-in-water type, allows fat and oil to be easily emulsified immediately after being added, is excellent in the effect of releasing cooked rice, reduces the breakage of rice grains and makes the graininess of rice excellent, suppresses aging of cooked rice, and allows cooked rice with improved richness and an excellent flavor to be obtained.

### Solution to Problem

As a result of intensive studies to solve the problems described above, the present inventors found that the problems can be solved by compounding a cooked rice improver with fat and oil, an ionic surfactant, and a polyhydric alcohol, adjusting the content of fat and oil, and adjusting the difference in lightness between the cooked rice improver and an emulsion thereof. The present inventors have completed the present invention based on these findings.

Specifically, according to one aspect of the present invention,
the provided is a cooked rice improver containing fat and oil, an ionic surfactant, and a polyhydric alcohol, wherein
a content of the fat and oil is 8% by mass or more and 65% by mass or less with respect to a total amount of the cooked rice improver, and
a difference of L2 value−L1 value calculated by the following definition at 20° C. is positive:
L1 value: lightness value of the cooked rice improver;
L2 value: lightness value of an emulsion obtained by adding 100 times by mass of fresh water to cooked rice improver.

In embodiments of the present invention, the viscosity of the cooked rice improver at 20° C. is preferably 50,000 mPa·s or less.

In embodiments of the present invention, the moisture content is preferably 5% by mass or more and 30% by mass or less with respect to the total amount of the cooked rice improver.

In embodiments of the present invention, the polyhydric alcohol contains preferably glycerin and/or a sugar alcohol.

In embodiments of the present invention, the content of the polyhydric alcohol is preferably 20% by mass or more in terms of solid content with respect to the total amount of the cooked rice improver.

In embodiments of the present invention, the ionic surfactant contains preferably lysophospholipid.

In embodiments of the present invention, the content of the ionic surfactant is preferably 0.1% by mass or more and 10% by mass or less with respect to the total amount of the cooked rice improver.

In embodiments of the present invention, the difference of L2 value−L1 value is preferably 10.0 or more.

In addition, according to another aspect of the present invention,
the provided is a method of producing cooked rice, comprising a step of adding a mixture containing fat and oil, an ionic surfactant, and a polyhydric alcohol, wherein
a content of the fat and oil is 8% by mass or more and 65% by mass or less with respect to a total amount of the mixture, and
a difference of L2 value−L1 value calculated by the following definition at 20° C. is positive:
L1 value: lightness value of the mixture;
L2 value: lightness value of an emulsion obtained by adding 100 times by mass of fresh water to the mixture.

### Advantageous Effects of Invention

According to the present invention, it is possible to provide a cooked rice improver, which is not pre-emulsified into an oil-in-water type, allows fat and oil to be easily emulsified immediately after being added, is excellent in the effect of releasing cooked rice, reduces the breakage of rice grains and makes the graininess of rice excellent, suppresses aging of cooked rice, and allows cooked rice with improved richness and an excellent flavor to be obtained.

In general, the addition of oil as a releasing agent is not preferable from the standpoint of the flavor of cooked rice. In particular, an emulsified rice cooking oil has a high moisture content due to its property of oil-in-water type (O/W type). Therefore, the amount of water to be added for rice cooking must be adjusted according to the amount of such rice cooking oil added, which tends to complicate the work on site. The cooked rice improver of the present invention can control the moisture content to a lower level than conventional cooked rice improvers, and can exert its effect even when used in a small amount, Therefore, there is substantially no extra moisture brought into the cooker during rice cooking, and there is no need to adjust the amount of water added during rice cooking such that workability can be improved.

### DESCRIPTION OF EMBODIMENTS

### <Cooked Rice Improver>

The cooked rice improver of the present invention contains at least fat and oil, an ionic surfactant, and a polyhydric alcohol, and thus can improve the quality of cooked rice and workability upon production of cooked rice, According to the present invention, the quality of cooked rice refers to the graininess, aging prevention, and flavor of cooked rice, and workability upon production of cooked rice refers to the emulsifiability of fat and oil, releasability of cooked rice, and the like.

### (Cooked Rice)

According to the present invention, cooked rice includes not only cooked rice obtained by cooking white rice or brown rice but also barley rice obtained by cooking white rice and barley together, sticky rice (okowa) obtained by cooking or steaming polished glutinous rice, and the like. Cooked rice also includes cooked processed rice such as a variety of mixed rice, fried rice, porridge, rice boiled in tea with salt, vinegared rice, festive red rice, and rice with ingredients such as chestnuts or beans, retort cooked rice, and aseptic packaged rice. In addition, cooked rice also includes products that are distributed and sold at room temperature, refrigerated, or frozen.

### (L Value)

When measuring the L value that represents the lightness of color using a colorimetric color difference meter at 20° C., the cooked rice improver has the property of having a positive value of the difference between the lightness, L1 value, of the cooked rice improver and the lightness, L2 value, of an emulsion obtained by adding 100 times by mass of fresh water to the cooked rice improver (L2 value−L1 value).

The L value is a numerical value representing the lightness of a color, and the larger the value, the brighter the color. In the case of an emulsion, as the emulsified particles become finer, the amount of scattered light increases and the particles become whitish. Accordingly, the L value increases. The change in the L value in the present invention is caused by adding the cooked rice improver to water, which causes a phase transition, resulting in an emulsion in which fat and oil are finely divided into fine particles, resulting in cloudiness and a decrease in transparency. The L value can be measured using a colorirnetric color difference meter (trade name: “Color Meter ZE-2000” manufactured by NIPPON DENSHOKU INDUSTRIES CO., LTD.) in the present invention.

“Self-emulsifiability” refers to the property of easily being an emulsified state (O/W emulsification) in which oil and fat are microparticulate by adding water to the oil and fat. The cooked rice improver of the present invention maintains the state before self-emulsification when added to water to form an O/W emulsion. Self-emulsifiability is a feature found in a system in which an infinite aggregate of molecules that aggregate infinitely is formed, such as a liquid crystal, a bicontinuous microemulsion (BCME), in which surfactant molecules aggregate infinitely, or the like. There is a proportional relationship between the stability of the system and the high self-emulsifiability. The details of the structure of the cooked rice improver of the present invention are not clear. However, as the cooked rice improver of the present invention exhibits self-emulsifiability by adding water, it is presumed to be a system in which an infinite aggregate is formed or a system having a state similar thereto. The cooked rice improver of the present invention can improve workability in the production step because fat and oil can be easily emulsified immediately after the cooked rice improver is added. In addition, since the cooked rice improver of the present invention does not need to be pre-emulsified, it is also possible to prevent voxidative deterioration of oil and fat.

When the cooked rice improver of the present invention has a high level of self-emulsifiability, the size of the fat and oil particles in the O/W emulsion obtained when a large amount of water is added becomes small, resulting in a large L2 value. Since the level of self-emulsifiability is proportional to the stability of the cooked rice improver as described above, the L2 value represents the stability of the cooked rice improver. Therefore, the greater the difference between the L1 value of the cooked rice improver (in a state before adding water) and the L2 value of the emulsion obtained by adding 100 times by mass of water to the cooked rice improver (L2 value−L1 value), the more stable the structure of the cooked rice improver is maintained. Thus, fat and oil can be readily emulsified immediately after the cooked rice improver is added. In addition, although the detailed principles are unknown, it is presumed that the resulting OW emulsion has small oil particles and easily permeates the cooked rice in the present invention Therefore, cooked rice in which the breakage of rice grains is reduced, the graininess of rice is excellent, aging is suppressed, and which has improved richness and an excellent flavor without a sensible oily smell can be obtained.

According to the present invention, the difference of L2 value−L1 value for the cooked rice improver is positive and preferably 10 or more, more preferably 15 or more, still more preferably 20 or more. When the difference of L2 value−L1 value for the cooked rice improver is positive, fat and oil can be easily emulsified immediately after the cooked rice Improver is added, and cooked rice, which has improved richness and an excellent flavor, can be obtained without imparting an oily smell due to oxidation to the cooked rice. Meanwhile, when the difference of L2 value−L1 value is negative, the effect of preventing aging cannot be obtained, and a strong oily smell is felt.

### (Viscosity of Cooked Rice Improver)

The viscosity of the cooked rice improver at 20° C. is 50,000 mPa·s or less, preferably 30,000 mPa·s or less, more preferably 10,000 mPa·s, still more preferably 5,000 mPa·s or less, and also preferably 100 mPa·s or more, more preferably 500 mPa·s or more, still more preferably 1,000 mPa·s or more. As long as the viscosity of the cooked rice improver is within the above-described range, fat and oil can be easily emulsified Immediately after the cooked rice improver is added, and also workability can be improved.

The viscosity of the cooked rice improver is a value that is calculated using a BL-type viscometer at a product temperature of 20° C. and a rotation speed of 6 rpm, based on the reading after 3 minutes from the start of measurement using No. 2 rotor when the viscosity is less than 3000 mPa·s, No. 3 rotor when the viscosity is 3000 mPa·s or more and less than 5000 mPa·s, and No. 4 rotor when the viscosity is 5000 mPa·s or more.

### (Fat and Oil)

The fat and oil compounded in the cooked rice improver are not particularly limited, and conventionally known edible fats and oils can be used. Specific examples of edible fats and oils that can be used include vegetable oils such as rapeseed oil, soybean oil, corn oil, palm oil, cottonseed oil, sunflower oil, safflower oil, sesame oil, olive oil, linseed oil, rice oil, camellia oil, perilla sesame oil, grapeseed oil, peanut oil, almond oil, and avocado oil, fish oil, algal oil containing DHA, beef tallow, lard, chicken fat, and fats and oils obtained by chemical or enzymatic treatment, such as MCT (medium-chain fatty acid triglyceride), diglyceride, hydrogenated oil, and transesterified oil. It is more preferable from a standpoint of health that these natural fats and oils contain phytochemicals (such as vitamin K, vitamin D, tocopherol, tocotrienol, γ-oryzanol, and polyphenol). Among these, it is preferable to use vegetable oils and fats, and it is more preferable to use rice oil, rapeseed oil, soybean oil, corn oil, or a mixed oil thereof.

The cooked rice improver of the present invention is effective in that these fats and oils can be easily added to cooked rice. Therefore, fat-soluble functional ingredients can be added to cooked rice, or fats and oils susceptible to oxidative deterioration can be added to cooked rice without being oxidatively deteriorated until just before the addition.

The content of fat and oil is 8% by mass or more and 65% by mass or less, preferably 10% by mass or more and 60% by mass or less, more preferably 15% by mass or more and 55% by mass or less, still more preferably 20% by mass or more and 50% by mass or less with respect to the total amount of the cooked rice improver. As long as the content of fat and oil is within the above-described numerical range, the cooked rice Improver allows fat and oil to be easily emulsified immediately after being added, is excellent in the effect of releasing cooked rice, reduces the breakage of rice grains and makes the graininess of rice excellent, suppresses aging of cooked rice, and allows cooked rice with improved richness and an excellent flavor to be obtained, Meanwhile, when the content is below the lower limit, the cooked rice improver does not have a sufficient effect of releasing cooked rice. In addition, when the content is above the upper limit, the cooked rice improver does not form a stable emulsion or does not allow fat and oil to be easily emulsified immediately after being added.

### (Ionic Surfactant)

The ionic surfactant compounded in the cooked rice improver ionizes and generates ions when dissolved in water. There are three types of ionic surfactants: anionic surfactants, cationic surfactants, and zwitterionic surfactants. According to the present invention, at least one ionic surfactant selected from the above-described three ionic surfactants is contained. In addition, the origin of the ionic surfactant may be natural, synthetic, or semi-synthetic.

Examples of anionic surfactants include organic acid monoglyceride in which an organic add (acetic add, lactic add, citric acid, succinic add, diacetyltartaric add, or the like) is further bound to the hydroxyl group of monoglyceride, perfluorocarboxylic add or a salt thereof, alkyl sulfates such as sodium dodecyl sulfate and ammonium lauryl sulfate, phosphatidylinositol, and phosphatidylglycerol.

Examples of cationic surfactants include quaternary ammonium salts such as benzalkonium chloride and benzethonium chloride,

Examples of zwitterionic surfactants include alkyl betaines such as stearyl betaine and lauryl betaine, alkylamine oxides such as lauryldimethylamine oxide, phospholipids such as phosphatidylcholine, phosphatidylethanolamine, phosphatidylserine, and phosphatidylcholine, and lysophospholipids that are lysoforms of these lipids.

Surfactants also include emulsifying materials that have similar effects to surfactants.

According to the present invention, when an amphoteric ionic surfactant is used among the three types of surfactants, the cooked rice improver can be easily formed in an emulsified state, and the aging of the cooked rice can be more effectively suppressed. A zwitterionic surfactant is a surfactant whose ionicity changes depending on the pH. When the hydrophilic group thereof is negatively charged, it shows properties of an anionic surfactant, and when the hydrophilic group thereof is positively charged, it shows properties of a cationic surfactant. In other words, when the cooked rice improver shown in the present invention is prepared, the cooked rice improver always acts as an ionic surfactant regardless of the ionicity of the components thereof. Thus, the cooked rice improver of the present invention having self-emulsifiability is likely to be formed. Also when a self-emulsifying product is obtained by adding water to the cooked rice improver, a fine and stable O/W emulsion can be obtained without being affected by the coexistence of ionic components (such as a salt) other than water.

A fatty add constituting the zwitterionic surfactant used in the present invention is preferably saturated from the viewpoint of more effectively suppressing oxidation of fat and oil. When the fatty add constituting the zwitterionic surfactant is saturated, the surfactant itself is less likely to be oxidized. It is also presumed that the unsaturated fatty add portion of the compounded fat and oil is mixed at the molecular level in a system in which an infinite aggregate is formed or in a state similar to that such that an effect of suppressing the chain of auto-oxidation is also obtained.

The saturated fatty add constituting the zwitterionic surfactant easily forms an emulsified state of the cooked rice improver, and the aging of the cooked rice is more effectively suppressed. In view of this, the saturated fatty acid content is preferably 40% or more, more preferably 65% or more in terms of the mass ratio of the total fatty acid constituting the fatty acid.

According to the present invention, the cooked rice improver can be easily formed in an emulsified state, and the aging of the cooked rice can be more effectively suppressed. In view of this, phospholipids are preferably used among the zwitterionic surfactants. Phospholipids are lipids having phosphate and phosphonate esters and are amphiphiles having both hydrophilic and hydrophobic groups. Examples of phospholipids include: glycerophospholipids having a glycerol skeleton such as phosphatidylcholine, phosphatidylethanolamine, phosphatidylserine, and phosphatidylinositol; and sphingophospholipids having a sphingosine skeleton such as sphingomyelin. Among phospholipids, phosphatidylcholine, phosphatidylethanolamine, and phosphatidylinositol are preferably used. Mixtures containing these phospholipids, such as various lecithins, are preferably used. Examples of lecithins include plant lecithins such as soybean lecithin, rapeseed lecithin, and sunflower lecithin, and egg yolk lecithin. It is preferable to use a plant lecithin because it is derived from a plant. When a mixture containing a phospholipid is used, the included phospholipid portion corresponds to the ionic surfactant of the present invention. For example, when egg yolk lecithin (such as PL-30 or LPL-20S manufactured by Kewpie Corporation) is used, the phospholipid contained in the mixture corresponds to the ionic surfactant of the present invention, and the egg yolk oil portion corresponds to the fat and oil of the present invention.

### (Lysophospholipid)

According to the present invention, aging can be more effectively suppressed by using the lysophospholipid that is a lysoform of the phospholipid described above. It is preferable to use, for example, lysophosphatidylcholine, lysophosphatidylethanolamine, or lysophosphatidylinositol as the lysophospholipid.

The content of the ionic surfactant is preferably 0.1% by mass or more and 10% by mass or less, more preferably 0.3% by mass or more and 8% by mass or less, still more preferably 0.5% by mass or more and 5% by mass or less with respect to the total amount of the cooked rice improver. As long as the content of the ionic surfactant is within the above-described range, fat and oil can be easily emulsified immediately after the cooked rice improver is added such that the effect of preventing the aging of cooked rice can be improved.

### (Polyhydric Alcohol)

The polyhydric alcohol compounded in the cooked rice improver collectively refers to alcohols having two or more hydroxy groups in the molecule. Examples thereof include: glycerin, ethylene glycol, propylene glycol, or polymers thereof, alkanediols such as 1,3-butanediol, 1,4-butanediol, and 1,2-propanediol; and sugar alcohols such as maltitol, lactitol, sorbitol, xylitol, erythritol, reduced palatinose, and reduced starch syrup. Among these, glycerin and sugar alcohols are preferable, and sugar alcohols are more preferable. Further, the average molecular weight of a sugar alcohol is preferably from 100 to 2000, more preferably from 150 to 1000. According to the present invention, polyhydric alcohol is used such that the cooked rice improver allows fat and oil to be easily emulsified immediately after being added, is excellent in the effect of releasing cooked rice, reduces the breakage of rice grains and makes the graininess of rice excellent, suppresses aging of cooked rice, and allows cooked rice with improved richness and an excellent flavor to be obtained.

The polyhydric alcohol may be used in either the powder form or the liquid form. When a polyhydric alcohol in the liquid form is used, the content of polyhydric alcohol is obtained in terms of solid content. The content of polyhydric alcohol is preferably 20% by mass or more, more preferably 25% by mass or more, still more preferably 30% by mass or more, yet still more preferably 35% by mass or more, and also preferably 60% by mass or less, more preferably 55% by mass or less, still more preferably 50% by mass or less in terms of solid content with respect to the total amount of the cooked rice improver. As long as the content of polyhydric alcohol is within the above-described numerical range, the cooked rice improver allows fat and oil to be more easily emulsified immediately after being added, is more excellent in the effect of releasing cooked rice, further reduces the breakage of rice grains and makes the graininess of rice excellent, further suppresses aging of cooked rice, and allows cooked rice with further improved richness and an excellent flavor to be obtained.

### (Moisture)

The cooked rice improver may contain moisture for emulsification and viscosity adjustment. When the cooked rice improver contains moisture, it may be compounded with fresh water, or the moisture may be derived from a raw material to be compounded, for example, a liquid sugar containing moisture as polyhydric alcohol.

The moisture content is preferably 30% by mass or less, more preferably 25% by mass or less, and still more preferably 22% by mass or less, and it may be also 0% by mass or more, 5% by mass or more, or 10% by mass or more with respect to the total amount of the cooked rice improver. The moisture content is adjusted to the above-described upper limit or less such that there is substantially no extra moisture brought into the cooker during rice cooking, and there is no need to adjust the amount of water added during rice cooking such that workability can be improved.

In addition, the moisture content is adjusted to the above-described lower limit or less such that viscosity can be adjusted to low levels, and as a result, fat and oil can be easily emulsified immediately after the cooked rice improver is added, and also workability can be improved.

### (Other Raw Materials)

The cooked rice improver can be compounded with various raw materials usually used in cooked rice improvers, which can be selected as appropriate, in addition to the above-described raw materials to the extent that the effects of the present invention are not impaired. Examples of other raw materials include organic acids such as acetic acid and citric acid, amino acids, salts, sweeteners, thickeners, coloring agents, flavoring agents, and preservatives.

### (Method of Preparing Cooked Rice Improver)

The method of preparing a cooked rice improver is not particularly limited, and conventionally known methods can be used. For example, a cooked rice improver can be prepared by loading an ionic surfactant, a polyhydric alcohol, fresh water, and optionally, other raw materials such as a salt and a sweetener into a stirring tank, stirring and mixing the mixture using a mixer to homogenize the mixture, and then gradually adding an edible oil while stirring.

### (Production Equipment)

To prepare the cooked rice improver of the present invention, equipment used in ordinary food production can be used. Examples of such equipment include a general stirrer, a stick mixer, a stand mixer, a homomixer, and a homodisper. Examples of the shape of the stirring blades of the stirrer include propeller blades, turbine blades, paddle blades, and anchor blades.

### <Method of Producing Cooked Rice>

The method of producing cooked rice of the present invention comprises at least a step of adding a mixture containing fat and oil, an ionic surfactant, and a polyhydric alcohol. As for the mixture, those having the same composition as the above-described cooked rice improver of the present invention can be used. The method of adding the mixture to the rice and the method of cooking the rice are not particularly limited, and conventionally known methods can be used. Moreover, the timing of adding the mixture to the rice is not particularly limited, and may be before the rice is cooked, at the same time as the rice is cooked, or after the rice is cooked.

### EXAMPLES

The present invention will be described in more detail below with reference to Examples and Comparative Examples, but the present invention should not be construed as being limited to the contents of the following Examples.

### Examples 1 to 7, Comparative Examples 1 to 4

### <Preparation of Cooked Rice Improver>

Cooked rice improvers were prepared according to the mixing proportions shown in Table 1. Specifically, a polyhydric alcohol (sugar alcohol (with an average molecular weight of from 150 to 1000) or glycerin), an ionic surfactant (lysophospholipid), and water are added to a glass beaker and stirred and mixed with an anchored propeller such that the mixture was homogenized. Thereafter, while stirring was continued, edible fat and oil (such as rapeseed oil) were gradually added, thereby preparing a cooked rice improver.

### Comparative Example 5

A commercially available cooked rice improver (an oil-in-water emulsion containing vegetable oil, a polyhydric alcohol, an emulsifier (derived from soybean), and the like as main ingredients) was used.

### <Evaluation of Cooked Rice Improver>

### (Measurement of L Value)

Using the above-described cooked rice improver, the L value of each sample before and after dilution with water was measured three times at 20° C. by the following method. The average was adopted to calculate the difference of L2 value−L1 value. The results are shown in Tables 1 and 2. For Comparative Examples 2 and 3 in which measurement was not possible because the cooked rice improver separated immediately after production, the results are indicated as unmeasured (“-”) in Table 1.

### Measuring Apparatus

Colorimetric color difference meter (Color Meter ZE-2000 manufactured by NIPPON DENSHOKU INDUSTRIES CO., LTD.)

### Measurement Conditions

L1 value: lightness value of cooked rice improver

The cooked rice improver before dilution with water was placed in an amount of 1.5 g in a circular cell and subjected to measurement.
L2 value: lightness value of emulsion obtained by adding 100 times by mass of fresh water to the cooked rice improver

The cooked rice improver before dilution was collected in an amount of 0.2 g in a beaker, and 20.0 g of fresh water was added and stirred. The obtained sample diluted with water was placed in an amount of 1.5 g in a circular cell and subjected to measurement.

### (Measurement of Viscosity)

The viscosity (mPa·s) of the above-described cooked rice improver was calculated using a BL-type viscometer at a product temperature of and a rotation speed of 6 rpm, based on the reading after 3 minutes from the start of measurement using No, 2 rotor when the viscosity was less than 3000 mPa·s, No. 3 rotor when the viscosity was 3000 mPa·s or more and less than 5000 mPa·s, and No. 4 rotor when the viscosity was 5000 mPa·s or more, The viscosity was measured three times for each cooked rice improver, and the average value was adopted. Tables 1 and 2 show the measurement results. For Comparative Examples 2 and 3 in which measurement was not possible because the cooked rice improver separated immediately after production, the results are indicated as unmeasured (“-”) in Table 1.

### <Production of Cooked Rice>

Uncooked rice in an amount of 450 g was thoroughly washed and soaked in water for 60 minutes for sufficient water absorption, Next, after draining the soaked rice, the rice was placed in a commercially available rice cooker, and water was added such that the total weight of the soaked rice and water was 1150 g. Subsequently, 14 g of the above-described cooked rice improver was added and lightly stirred, and cooked the rice. After the rice is cooked, the cooked rice was taken out from the rice cooker and cooled to 25° C. with a vacuum cooler.

### (Emulsifiability)

Emulsifiability (workability), when added during rice cooking described above, was evaluated according to the following criteria. The evaluation results are shown in Tables 1 and 2, In the following evaluation, if the evaluation is “⊚”, “◯” or “Δ”, it can be said that the result is favorable. For Comparative Examples 2 and 3 in which measurement was not possible because the cooked rice improver separated immediately after production, the results are indicated as unmeasured (“-”) in Table 1.

### Evaluation Criteria for Emulsifiability of Cooked Rice Improver

⊚: Just by simply stirring with a rice scoop immediately after adding the cooked rice improver, a uniform milky white color was obtained after a few seconds.
◯: Just by simply stirring with a rice scoop immediately after adding the cooked rice improver, a uniform milky white color was obtained after about ten seconds.
Δ: Immediately after adding the cooked rice improver, simply stirring with a rice scoop took some time to homogenize. However, there were no practical problems.
x: Immediately after adding the cooked rice improver, even strong stirring with a rice scoop for a while could not achieve a perfectly homogenized state. As a result, a lump remained

### (Releasability)

The releasability of the above cooked rice was evaluated according to the following criteria. After cooking the rice, the rice cooker was turned over to take out the cooked rice, and the remaining rice grains and rice starch paste at the bottom of the cooker were visually checked. The evaluation results are shown in Tables 1 and 2. In the following evaluation, if the evaluation is “⊚” or “◯”, it can be said that the result is favorable. For Comparative Examples 2 and 3 in which measurement was not possible because the cooked rice improver separated immediately after production, the results are indicated as unmeasured (“-”) in Table 1.

### Evaluation Criteria for Releasability of Cooked Rice

⊚: The cooked rice was easily released from the cooker while no rice grains or starch paste remained.
∘: The cooked rice was easily released from the cooker while no rice grains remained but a little starch paste remained.
x: The cooked rice was not easily released from the cooker while rice grains remained,

### (Sensory Evaluation)

The graininess, effect of preventing aging, and flavor of the cooked rice described above were sensory evaluated by a plurality of trained panels according to the following criteria. The control plot refers to cooked rice cooked in the same manner as described above without adding the cooked rice improver. The evaluation results are shown in Tables 1 and 2, In the following evaluation, if the evaluation is “⊚”, “◯” or “Δ”, it can be said that the result is favorable. For Comparative Examples 2 and 3 in which measurement was not possible because the cooked rice improver separated immediately after production, the results are indicated as unmeasured (“-”) in Table 1.

### Evaluation Criteria for Graininess of Cooked Rice

⊚: The graininess of cooked rice was excellent, resulting in a significantly preferable texture of cooked rice.
◯:The graininess of cooked rice was excellent, resulting in a preferable texture of cooked rice.
x: The graininess of cooked rice was poor and the rice grains were fragile, resulting in a non-preferable texture of cooked rice.

### Evaluation Criteria for Effect of Preventing Aging of Cooked Rice

∘: The cooked rice was prevented from aging and had moderate stickiness and elasticity.
x: Due to the aging of rice, the rice was not sticky and had a crumbly texture.

### Evaluation Criteria for Flavor of Cooked Rice

⊚: The cooked rice had a stronger and more intensified rich taste than the control plot.
◯: The cooked rice had a more intensified rich taste than the control plot.
Δ: A The cooked rice had a slightly more intensified rich taste than the control plot, and a slightly oily smell was felt.
x: The cooked rice did not have an intensified rich taste compared to the control plot, and an oily smell was strongly felt.

TABLE 1

| | Comp. | | | | | | | Comp. | Comp. | Comp. | |
|---|---|---|---|---|---|---|---|---|---|---|---|
| Composition | Ex. 1 | Ex. 1 | Ex. 2 | Ex. 3 | Ex. 4 | Ex. 5 | Ex. 6 | Ex. 2 | Ex. 3 | Ex. 4 | Ex. 7 |
| Edible fat and oil | 7.4 | 17.4 | 32.4 | 32.2 | 47.4 | 57.2 | 50.0 | 94.0 | 67.4 | 84.0 | 62.0 |
| Sugar alcohol (in | 64.4 | 57.4 | 46.9 | 49.2 | 36.4 | 25.2 | 31.5 | 3.5 | 22.4 | 0.0 | 0.0 |
| terms of solid content) | | | | | | | | | | | |
| Glycerin | 0.0 | 0.0 | 0.0 | 0.0 | 0.0 | 0.0 | 0.0 | 0.0 | 0.0 | 15.0 | 35.5 |
| Lysophospholipid | 0.6 | 0.6 | 0.6 | 0.6 | 0.6 | 1.8 | 5.0 | 1.0 | 0.6 | 1.0 | 2.5 |
| Moisture | 27.6 | 24.6 | 20.1 | 18.0 | 15.6 | 15.8 | 13.5 | 1.5 | 9.6 | 0.0 | 0.0 |
| Total (% by mass) | 100.0 | 100.0 | 100.0 | 100.0 | 100.0 | 100.0 | 100.0 | 100.0 | 100.0 | 100.0 | 100.0 |
| L2 value − L1 value | 4.3 | 16.8 | 18.2 | 23.5 | 31.5 | 28.1 | 23.9 | — | — | 17.3 | 21.0 |
| Viscosity (mPa · s) | 600 | 1300 | 3500 | 4000 | 9000 | 29000 | 45500 | — | — | >100000 | 49500 |
| Emulsifiability | ⊚ | ⊚ | ⊚ | ⊚ | ◯ | Δ | Δ | — | — | X | Δ |
| Releasability | X | ◯ | ⊚ | ⊚ | ⊚ | ◯ | ◯ | — | — | ◯ | ◯ |
| Graininess | ◯ | ◯ | ⊚ | ⊚ | ⊚ | ◯ | ◯ | — | — | X | ◯ |
| Aging prevention | ◯ | ◯ | ◯ | ◯ | ◯ | ◯ | ◯ | — | — | X | ◯ |
| Flavor | ⊚ | ⊚ | ⊚ | ⊚ | ⊚ | ⊚ | ⊚ | — | — | Δ | ◯ |

TABLE 2

| | Comp. |
|---|---|
| | Ex. 5 |
| L2 value − L1 value | −10.1 |
| Viscosity | 3500 |
| Emulsifiability | — |
| Releasability | ∘ |
| Graininess | ∘ |
| Aging prevention | x |
| Flavor | x |

All of the cooked rice improvers of Examples 1 to 7 could be easily emulsified immediately after being added, were excellent in the effect of releasing cooked rice, reduced the breakage of rice grains and made the graininess of rice excellent, suppressed aging of cooked rice, and allowed cooked rice with improved richness and an excellent flavor to be obtained.

Among the Example in which evaluation of emulsifiability was “Excellent,” emulsification was particularly easy in Example 3.

In addition, Examples 1 to 4 were excellent in the physical property of smoothness and the ease of loading, and in particular, Examples 1 to 3 were significantly excellent in the ease of loading.

The cooked rice improver of Comparative Example 1 had an excessively low fat and oil content, resulting in a poor release effect.

The cooked rice improvers of Comparative Examples 2 and 3 had an excessively high fat and oil content, causing the cooked rice improver immediately after being produced to separate. Therefore, subsequent evaluation could not be carried out.

The cooked rice improver of Comparative Example 4 had an excessively high fat and oil content, and thus was unlikely to emulsify resulting in poor graininess of cooked rice. Thus, aging could not be suppressed.

The cooked rice improver of Comparative Example 5 had a negative value of L2 value−L1 value, and thus aging could not be suppressed, and an oily smell was strongly felt from the rice.

1. A cooked rice improver containing fat and oil, an ionic surfactant, and a polyhydric alcohol, wherein
a content of the fat and oil is 8% by mass or more and 65% by mass or less with respect to a total amount of the cooked rice improver, and
a difference of L2 value−L1 value calculated by the following definition at 20° C. is positive:
L1 value: lightness value of the cooked rice improver;
L2 value: lightness value of an emulsion obtained by adding 100 times by mass of fresh water to the cooked rice improver.

2. The cooked rice improver according to claim 1, having a viscosity at 20° C. of 50,000 mPa·s or less.

3. The cooked rice improver according to claim 1, having a moisture content of 5% by mass or more and 30% by mass or less with respect to the total amount of the cooked rice improver.

4. The cooked rice improver according to claim 1, wherein the polyhydric alcohol contains glycerin and/or a sugar alcohol.

5. The cooked rice improver according to claim 1, wherein a content of the polyhydric alcohol is 20% by mass or more in terms of solid content with respect to the total amount of the cooked rice improver.

6. The cooked rice improver according to claim 1, wherein the ionic surfactant contains lysophospholipid.

7. The cooked rice improver according to claim 1, wherein a content of the ionic surfactant is 0.1% by mass or more and 10% by mass or less with respect to the total amount of the cooked rice improver.

8. The cooked rice improver according to claim 1, wherein the difference of L2 value−L1 value is 10.0 or more.

9. A method of producing cooked rice, comprising a step of adding a mixture containing fat and oil, an ionic surfactant, and a polyhydric alcohol, wherein
a content of the fat and oil is 8% by mass or more and 65% by mass or less with respect to a total amount of the mixture, and
a difference of L2 value−L1 value calculated by the following definition at 20° C. is positive:
L1 value: lightness value of the mixture;
L2 value: lightness value of an emulsion obtained by adding 100 times by mass of fresh water to the mixture.
